(19) United States
(12) Patent Application Publication
(10) Pub. No.: US 2009/0099877 A1
(43) Pub. Date: Apr. 16, 2009

(54) Systems and methods for underwriting risks utilizing epigenetic information

(76) Inventors: Roderick A. Hyde, Redmond, WA (US); Jordin T. Kare, Seattle, WA (US); Eric C. Leuthardt, St. Louis, MO (US); Dennis J. Rivet, Portsmouth, VA (US); Lowell L. Wood, JR., Bellevue, WA (US); Edward K.Y. Jung, Bellevue, WA (US)

Correspondence Address: IV - SUITER SWANTZ PC LLO, 14301 FNB PARKWAY , SUITE 220, OMAHA, NE, 68154, US

(21) Appl. No.: 11/974,166

(22) Filed: Oct. 11, 2007

(51) Int. Cl. G06Q 40/00

(52) U.S. Cl. 705/4

(57) ABSTRACT

Methods and devices are described for calculating insurance premiums based upon epigenetic information.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of United States Patent Application Express Mail Label No. EM005739164US, entitled SYSTEMS AND METHODS FOR UNDERWRITING RISKS UTILIZING EPIGENETIC INFORMATION, naming Roderick A. Hyde; Jordin T. Kare; Eric C. Leuthardt; Dennis J. Rivet; Michael A. Smith; and Lowell L. Wood, Jr. as inventors, filed Oct. 4, 2007, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

A method including but not limited to: reviewing epigenetic information for at least one individual; correlating at least one aspect of said epigenetic information for said at least one individual to a health risk; underwriting a financial risk at least partially based upon said correlation for at least one of said at least one individual and another individual; and setting a health insurance premium at least partially based upon said underwriting. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein- referenced method aspects depending upon the design choices of the system designer.

A device including but not limited to: means for reviewing epigenetic information for at least one individual; means for correlating at least one aspect of said epigenetic information for said at least one individual to a health risk; means for underwriting a financial risk at least partially based upon said correlation for at least one of said at least one individual or another individual; and means for setting a health insurance premium at least partially based upon said underwriting. In addition to the foregoing, other device aspects are described in the claims, drawings, and text forming a part of the present disclosure.

A device including but not limited to: circuitry for reviewing epigenetic information for at least one individual; circuitry for correlating at least one aspect of said epigenetic information for said at least one individual to a health risk; circuitry for underwriting a financial risk at least partially based upon said correlation for at least one of said at least one individual or another individual; and circuitry for setting a health insurance premium at least partially based upon said underwriting. In addition to the foregoing, other device aspects are described in the claims, drawings, and text forming a part of the present disclosure.

The foregoing summary is illustrative only and is NOT intended to be in any way Limiting. In addition to the illustrative aspects, examples, and features described above, further aspects, examples, and features will become apparent by reference to the drawings and the following detailed description.

### BRIEF DESCRIPTION OF THE FIGURES

FIG. 1 depicts an exemplary environment in which one or more technologies may be implemented.

FIG. 2 shows a logic flowchart for a method.

FIG. 3 illustrates variants for the flowchart in FIG. 2.

FIG. 4 depicts variants for the flowchart in FIG. 2.

FIG. 5 shows variants for the flowchart in FIG. 2.

FIG. 6 illustrates variants for the flowchart in FIG. 2.

FIG. 7 depicts variants for the flowchart in FIG. 2.

FIG. 8 shows variants for the flowchart in FIG. 2.

FIG. 9 illustrates a chart for a device.

FIG. 10 depicts variants for the device in FIG. 9.

FIG. 11 shows variants for the device in FIG. 9.

FIG. 12 illustrates variants for the device in FIG. 9.

FIG. 13 depicts variants for the device in FIG. 9.

FIG. 14 shows variants for the device in FIG. 9.

FIG. 15 illustrates variants for the device in FIG. 9.

FIG. 16 depicts variants for the device in FIG. 9.

FIG. 17 shows variants for the device in FIG. 9.

FIG. 18 illustrates a chart for a device.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented here.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

In one or more various aspects, related devices include but are not limited to circuitry and/or programming for effecting the herein-referenced method aspects; the circuitry and/or programming can be virtually any combination of hardware, software, and/or firmware configured to effect the herein- referenced method aspects depending upon the design choices of the device designer.

Those having skill in the art will recognize that the present application teaches modifications of the methods within the spirit of the teaching herein. For example, the methods described herein may be beneficial for reviewing epigenetic information for at least one individual and underwriting a risk at least partially based upon the epigenetic information for at least one individual. The epigenetic information reviewed may be used to identify a certain individual or population risk for partially determining underwriting risks.

Following are a series of flowcharts depicting implementations of processes. For ease of understanding, the flowcharts are organized such that the initial flowcharts present implementations via an overall “big picture” or “top-level” viewpoint and thereafter the subsequent flowcharts present alternate implementations or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to or further details in subsequent flowcharts) generally allows for a more rapid and reliable understanding of the various process implementations.

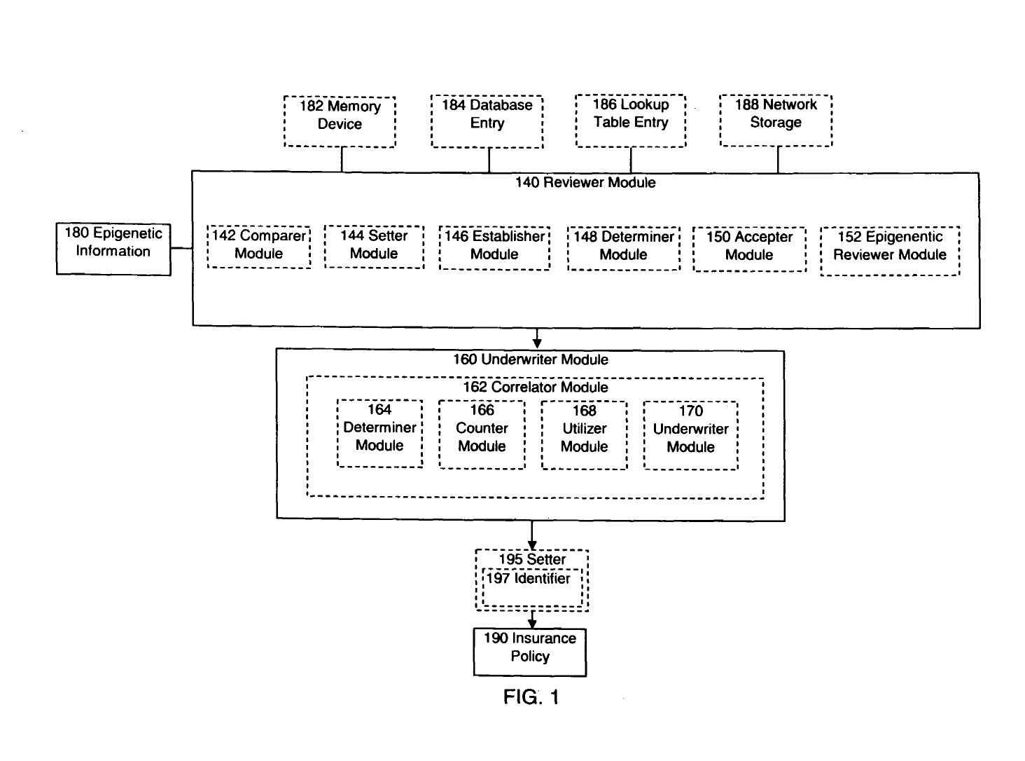

Referring to FIG. 1, depicted is one example of an illustrative environment of and/or for subject matter technologies relating to calculating an insurance premium utilizing epigenetic information. A reviewer module 140 may include a comparer module 142, a setter module 144, an establisher module 146, a determiner module 148, and/or an accepter module 150. An example of a reviewer module 140, a comparer module 142, a setter module 144, an identifier module 187, an establisher module 146, a determiner module 148, an accepter module 150, and/or an epigenetic information reviewer module 152 may include a computer processor. A reviewer module 140 may review epigenetic information module 180 and/or retrieve information from a memory device module 182, a database entry module 184, and/or a lookup table module 186. An underwriter module 160 may include a correlator module 162, a determiner module 164, a counter module 166, a utilizer module 168, and/or an underwriter module 170. An example of an underwriter module 160 may include a computer processor. An underwriter module 160 may underwrite a risk and/or issue an insurance policy 190. A setter module 195 and/or an identifier module 197 may include a computer processor.

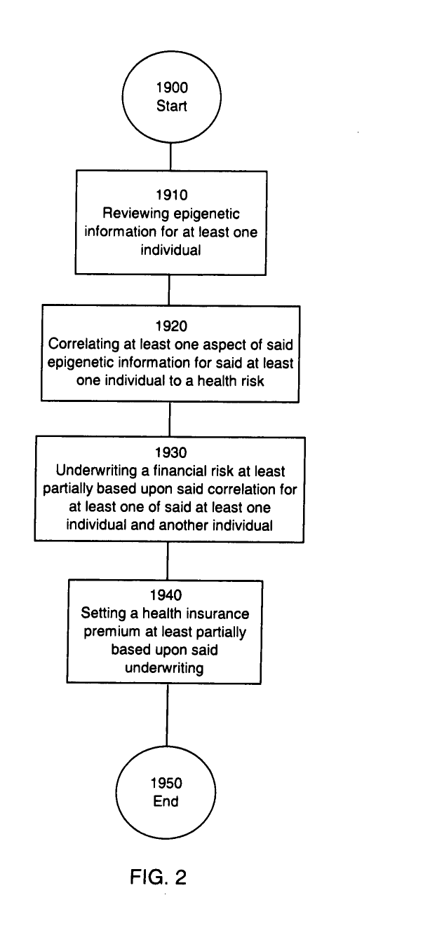

Referring generally to FIGS. 2 through 8, a method is disclosed for reviewing epigenetic information for at least one individual and underwriting a risk at least partially based upon the epigenetic information for at least one individual.

FIG. 2 illustrates a flowchart of a method. The method start is depicted at block 1900. Block 1910 depicts reviewing epigenetic information for at least one individual. In one implementation, a reviewer module 140 might receive from a memory device 182 an indication of how a DNA sequence of a specific human (e.g. John Smith) has been chemically/molecularly modified by one or more environmental influences (e.g. by a methylase and/or an acetylase arising from some materials present in a home/work setting). In some instances, a reviewer 140 may include a computer processor, an information collection center, or an insurance company. Further, reviewing epigenetic information may include collecting, conveying, and/or analyzing the epigenetic information. Block 1920 depicts correlating at least one aspect of epigenetic information for at least one individual to a health risk. In one implementation, and continuing with the example above, correlator module 162 may receive an indication from reviewer module 140 that John Smith has a certain methylation of a segment of DNA. Accordingly, correlator module 162 may be programmed to associate epigenetic information regarding how a DNA sequence of John Smith has been chemically/molecularly modified by one or more environmental influences to hypertension. In some instances, a correlator 162 may include a computer processor or actuarial tables. In various aspects, correlating at least one aspect of epigenetic information for at least one individual to a health risk may include, for example, at least one linear correlation, at least one nonlinear correlation, functional dependency or other mathematical relationship. Block 1930 depicts underwriting a financial risk at least partially based upon a correlation for at least one individual and another individual. In one implementation, and continuing further with the example above, risk underwriter module 160 receives an indication from correlator module 140 of an association between epigenetic information regarding DNA methylation and hypertension for John Smith. Accordingly, risk underwriter module 160 increases a quantified risk of hypertension for Mark Smith, brother of John Smith, beyond that which would have been assessed in the absence of the correlated epigenetic information for John Smith received from correlator module 140. In some instances, a financial risk underwriter 160 may include a computer processor, an insurance company, actuarial tables and/or mortality tables. The correlation may include a correlation between multiple individuals. For example, epigenetic information regarding one sibling may be the basis for epigenetic information regarding another sibling, and the correlation between the epigenetic information for the two siblings may be a base for underwriting a financial risk. Underwriting a risk may generally involve quantifying, selecting, classifying, analyzing, and assuming risk for an insurance applicant according to the degree of risk so that the applicant may be offered an appropriately configured product (policy). Block 1940 depicts setting a health insurance premium at least partially based upon the underwriting. In one implementation, still continued from the example above, setter module 195 may receive an indication from risk underwriter module 160 an increase in quantified risk for Mark Smith. Accordingly, setter module 195 may determine a health insurance premium of five hundred dollars per month for Mark Smith based upon the quantified risk increased by risk underwriter module 160. In some instances, a health insurance premium setter 144 may include a computer processor, an actuarial table, and/or a mortality table. Block 1950 depicts the end of the method.

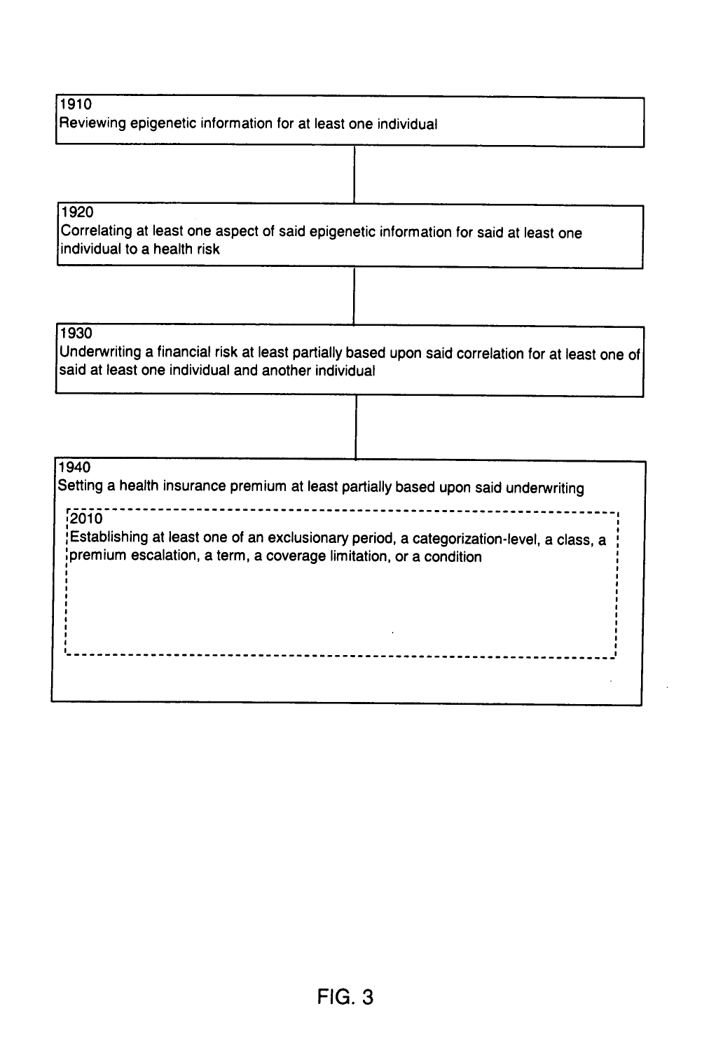

FIG. 3 shows aspects of the flowchart depicted in FIG. 2. Block 1910 depicts reviewing epigenetic information for at least one individual. Block 1920 depicts correlating at least one aspect of the epigenetic information for at least one individual to a health risk. Block 1930 depicts underwriting a financial risk at least partially based upon correlation for at least one individual and another individual. Block 1940 depicts setting a health insurance premium at least partially based upon underwriting. Optional block 2010 depicts setting a health insurance premium at least partially based upon underwriting by establishing at least one of an exclusionary period, a categorization-level, a class, a premium escalation, a term, a coverage limitation, or a condition. In a specific instance, establisher module 146 may set an exclusionary period of ninety days and a term of ten years for a health insurance policy with a premium of three hundred dollars per year for Mark Smith based upon quantified risk increased by risk underwriter module 160. In another specific instance, establisher module 146 may set a high risk categorization-level, a coverage limitation limiting coverage to not include pre-existing conditions, a premium escalation to include mandatory raised premiums after five years of coverage, and a condition that none of the applicants/insureds have pneumonia during the term for a health insurance policy for Mark Smith with a premium of four hundred dollars per month based on a quantified risk increased by risk underwriter module 160. In some instances, an establisher module 146 may include a computer processor, an actuarial table, and/or a mortality table. An exclusionary period may include a predetermined amount of time an insured may be required to wait before insurance coverage may begin. A categorization-level may include a predetermined group of insureds meeting a certain risk threshold. A class may include a predetermined group of people and/or insurance policies with similar attributes. A premium escalation may include a rise in insurance policy premium rates. A term may include a specified amount of time, such as a term of an insurance policy. A coverage limitation may include items not covered by an insurance policy, such as pre-existing conditions. A condition may include a situation potentially affecting the eligibility of insurance coverage, such as disease, injury, and/or illness.

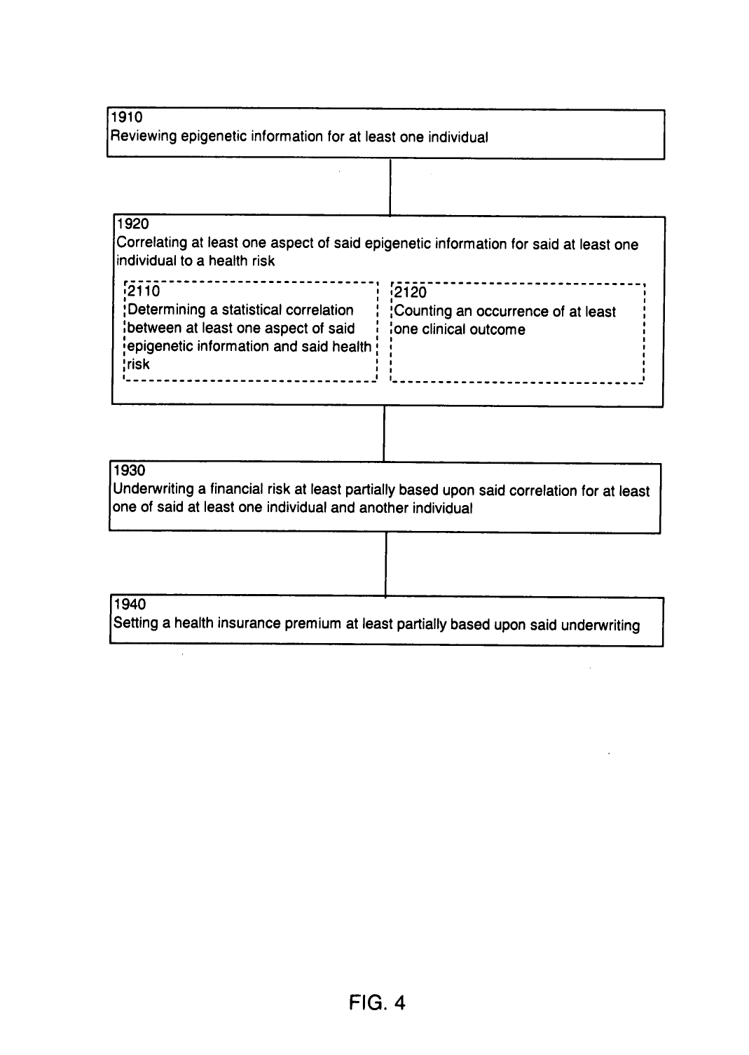

FIG. 4 shows aspects of the flowchart depicted in FIG. 2. Block 1910 depicts reviewing epigenetic information for at least one individual. Block 1920 depicts correlating at least one aspect of epigenetic information for at least one individual to a health risk. Optional block 2110 depicts correlating at least one aspect of epigenetic information for at least one individual to a health risk by determining a statistical correlation between at least one aspect of epigenetic information and a health risk. In one instance, determiner module 148 may be programmed to relate epigenetic information pertaining to methylation at a specific DNA base to lung cancer. In some instances, a statistical correlation determiner module 148 may include a computer processor or an actuarial table. A statistical correlation may include, for example, at least one linear correlation, at least one nonlinear correlation, functional dependency or other mathematical relationship. The statistical correlation may or may not be associated with some type of causality, real or implied, proven or unproven. Optional block 2120 depicts correlating at least one aspect of epigenetic information for at least one individual to a health risk by counting an occurrence of at least one clinical outcome. In one implementation, counter module 166 may be coded to determine the total number of occurrences of one or more results of a specific DNA methylation structure and the total number of occurrences of lung cancer in a major metropolitan city. In the same implementation, the number of occurrences of the specific DNA methylation structure and the number of occurrences of lung cancer may be analyzed by one or more analysis tools, such as a spreadsheet computer program (or some other computer program written for such purpose), to determine a relationship. In some instances, counter module 166 may include a computer processor. A counter 166 may include a computer processor. The counting an occurrence of at least one clinical outcome may include counting a single occurrence of an outcome, such as, for example, a genomic imprinting, a gene mutation, and/or a certain phenotype. Block 1930 depicts underwriting a financial risk at least partially based upon correlation for at least one individual and another individual. Block 1940 depicts setting a health insurance premium at least partially based upon underwriting.

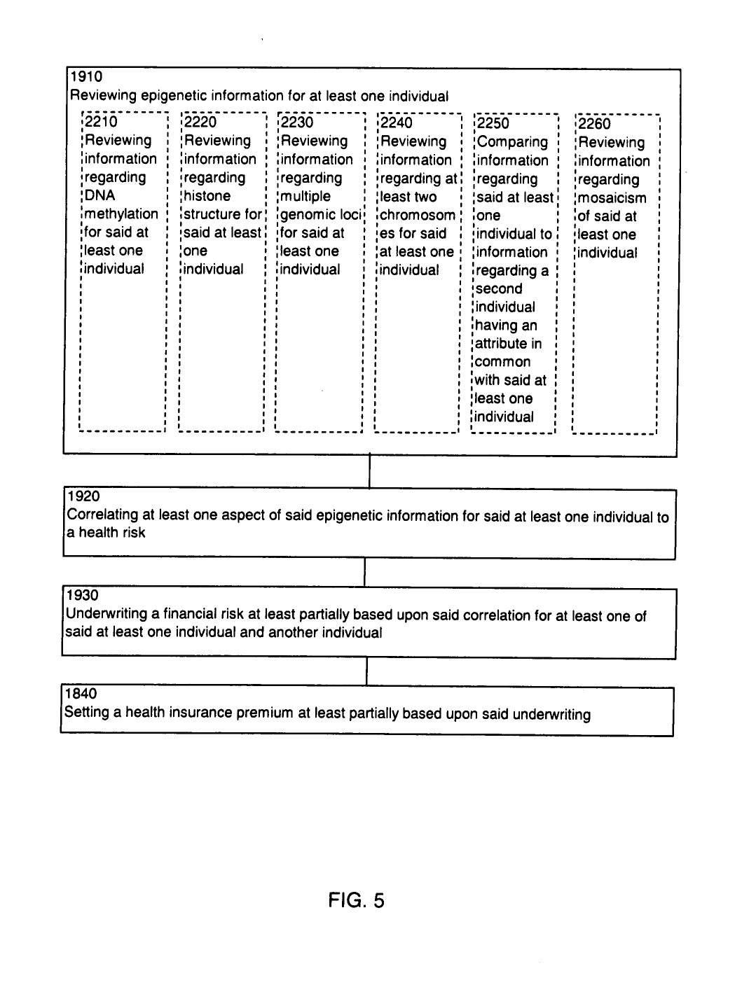

FIG. 5 shows aspects of the flowchart depicted in FIG. 2. Block 1910 depicts reviewing epigenetic information for at least one individual. Optional block 2210 depicts reviewing epigenetic information for at least one individual by reviewing information regarding DNA methylation for at least one individual. In one instance, epigenetic reviewer module 152 may retrieve from a database entry 184 associated with John Smith one or more results of a biochemical analysis indicative of the attachment of one or more methyl groups to at least a part of John Smith's DNA sequence. In some instances, an epigenetic information (DNA methylation) reviewer 152 may include a computer processor. For example, reviewing information regarding DNA methylation for at least one individual may include information regarding the methylation status of DNA generally or in the aggregate, or information regarding DNA methylation at one or more specific DNA loci, DNA regions, or DNA bases. See, for example: Shilatifard, Chromatin modifications by methylation and ubiquitination: implications in the regulation of gene expression, ANNUAL REVIEW OF BIOCHEMISTRY, 75:243-269 (2006); and Zhu and Yao, Use of DNA methylation for cancer detection and molecular classification, JOURNAL OF BIOCHEMISTRY AND MOLECULAR BIOLOGY, 40:135-141 (2007), each of which are incorporated herein by reference.

Optional block 2220 depicts reviewing epigenetic information for at least one individual by reviewing information regarding histone structure for at least one individual. In one instance, epigenetic reviewer module 152 may retrieve from a lookup table entry 186 associated with John Smith one or more results of a biochemical analysis indicative of a changes in the protein(s) about which at least a part of John Smith's DNA wraps between replications. In some instances, an epigenetic information (histone structure) reviewer module 152 may include a computer processor. For example, reviewing information regarding histone structure for at least one individual may include information regarding histone structure generally or in the aggregate, or histone structure at one or more specific locations including one or more chromosomes. Information regarding histone structure may, for example, include information regarding specific subtypes or classes of histones, such as H1, H2A, H2B, H3 or H4. Information regarding histone structure may have an origin in array-based techniques, such as described in Barski et al., High-resolution profiling of histone methylations in the human genome, CELL 129, 823-837 (2007), which is incorporated herein by reference.

Optional block 2230 depicts reviewing epigenetic information for at least one individual by reviewing information regarding multiple genomic loci for at least one individual. In one instance, epigenetic reviewer module 152 may retrieve from network storage 188 associated with John Smith one or more results of a biochemical analysis indicative of methylation and/or histone modification and/or other changes for at least two loci of John Smith's DNA genome. In some instances, an epigenetic reviewer module 152 may include a computer processor. In some examples reviewing information regarding multiple genomic loci for at least one individual may include information regarding multiple genomic loci throughout one or more genomes, multiple genomic loci located on one or more chromosomes or chromosomal arms, or multiple genomic loci located in a specific chromosomal region. Information regarding multiple genomic loci may also include information regarding different epigenetic effects at different genomic loci. See, for example, The ENCODE Project Consortium, Identification and analysis of functional elements in 1% of the human genome by the ENCODE pilot project, NATURE 447: 799-816 (2007), which is incorporated herein by reference. For example, in some examples the information regarding multiple genomic loci may include information regarding both DNA methylation and histone modifications. See, for example, Berger, The Complex Language of Chromatin Regulation During Transcription, NATURE 477, 407-412 (2007), and Greally, Encyclopaedia of Humble DNA, NATURE 447: 782-783 (2007), which are incorporated herein by reference. In some examples, the information regarding multiple genomic loci may include information regarding the predicted stability of the epigenetic status at the multiple genomic loci. See, for example, Dodd et al., Theoretical Analysis of Epigenetic Cell Memory by Nucleosome Modification, CELL 129, 813-822 (2007), which is incorporated herein by reference. In some examples, the information regarding multiple genomic loci may include information regarding the spatial relationship of the genomic loci within at least one cell. For example, see Fraser and Bickmore, Nuclear Organization of the Genome and the Potential for Gene Regulation, NATURE 477: 413-417 (2007), which is incorporated herein by reference. In some examples, the information regarding multiple genomic loci may include information regarding binding of one or more proteins to multiple genomic loci. See, for example, Xie et al., Systematic Discovery of Regulatory Motifs in Conserved Regions of the Human Genome, Including Thousands of CTCF Insulator Sites, PNAS USA 104: 7145-7150 (2007), which is incorporated herein by reference.

Optional block 2240 depicts reviewing epigenetic information for at least one individual by reviewing information regarding at least two chromosomes for at least one individual. In one instance, epigenetic reviewer module 152 may retrieve from a computer memory 182 assigned to John Smith one or more epigenetic changes (e.g., methylation(s)) respectively associated with each of a pair of John Smith's chromosomes. In some instances, an epigenetic information (chromosome information) reviewer module 152 may include a computer processor. In some examples, reviewing information regarding at least two chromosomes for at least one individual may include information regarding at least two homologous chromosomes, sister chromatids, or nonhomologous chromosomes. In some examples, at least one aspect of epigenetic information may include information regarding at least two chromosomes including the copy number of the at least two chromosomes. See, for example, Redon et al., Global Variation in Copy Number in the Human Genome, NATURE 444: 444-454 (2006) and Shianna and Willard, In Search of Normality, NATURE 444: 428-429 (2006), which are incorporated herein by reference.

Optional block 2250 depicts reviewing epigenetic information for at least one individual by comparing information regarding at least one individual to information regarding a second individual having an attribute in common with the first at least one individual. In one instance, comparer module 142 may be programmed to find epigenetic similarities for individuals identified as having developed hypertension past the age 40 and who are also identified as males. In response, comparer module 142 retrieves, from one or more databases, (i) epigenetic data (e.g., chromatin remodeling data) associated with John Smith, a male of age 50 identified as having developed high blood pressure at age 43, and (ii) epigenetic data (e.g., methylation data) associated with David Jones, a male of age 47 identified as having developed high blood pressure at age 41. Subsequently, comparer module 142 utilizes one or more analysis tools to determine a degree of epigenetic similarities between John Smith and Davy Jones. In some instances, a comparer module 142 may include a computer processor. For example, at least one aspect of epigenetic information may include information regarding two or more people with a common attribute such as gender, height, weight, diabetes status, heart disease status, medical diagnosis, familial background, results on one or more medical tests, or ethnic background. For example, a common attribute may include environmental attributes, such as exposure to a pathogen, a teratogen, a chemical substance.

Optional block 2260 depicts reviewing epigenetic information for at least one individual by reviewing information regarding mosaicism of at least one individual. In one instance, epigenetic information reviewer module 152 may be configured to locate/identify various environmental factors that might lead to mosaicism. Accordingly, epigenetic information reviewer module 152 may locate records for at least two individuals, for sake of example referred to herein as John Smith and Mike Jones, identified as having some shared specified form of mosaicism (e.g., both John Smith and Mike Jones have gonadal mosaicism, where some gametes carry a mutation, but the rest are normal). Thereafter, epigenetic information reviewer module 152 scans known work histories for both John Smith and Mike Jones and logs any shared/disjoint work environmental factors (e.g., known mutagens) associated with epigenetic changes. In some instances, epigenetic information reviewer module 152 notes the degree to which the work environmental factors are shared/disjoint. In some instances, epigenetic information (mosaicism) reviewer module 152 may include a computer processor. The term “mosaicism,” as used herein, may mean situations where two or more cellular subtypes arise during the lifespan of an organism, situations where two or more cellular subtypes originate with the first cell of an organism and situations where the origin of the cellular subtypes is unclear. The term “mosaicism” may generally include somatic mosaicism, gonadal mosaicism, or chimerism. For example, at least one aspect of epigenetic information may include information regarding mosaicism of at least one individual person such as the presence or absence of mosaicism, the location of mosaicism, the tissue or tissues involved in the mosaicism, or the proportion of various subtypes of cells in mosaic tissue. For more information on somatic mosaicism and disease, see Youssoufian and Pyeritz, Mechanisms and Consequences of Somatic Mosaicism in Humans, NATURE REVIEWS GENETICS 3: 748-758 (2002), which is incorporated herein by reference. Block 1920 depicts correlating at least one aspect of epigenetic information for at least one individual to a health risk. Block 1930 depicts underwriting a financial risk at least partially based upon correlation for at least one of at least one individual and another individual. Block 1940 depicts setting a health insurance premium at least partially based upon underwriting.

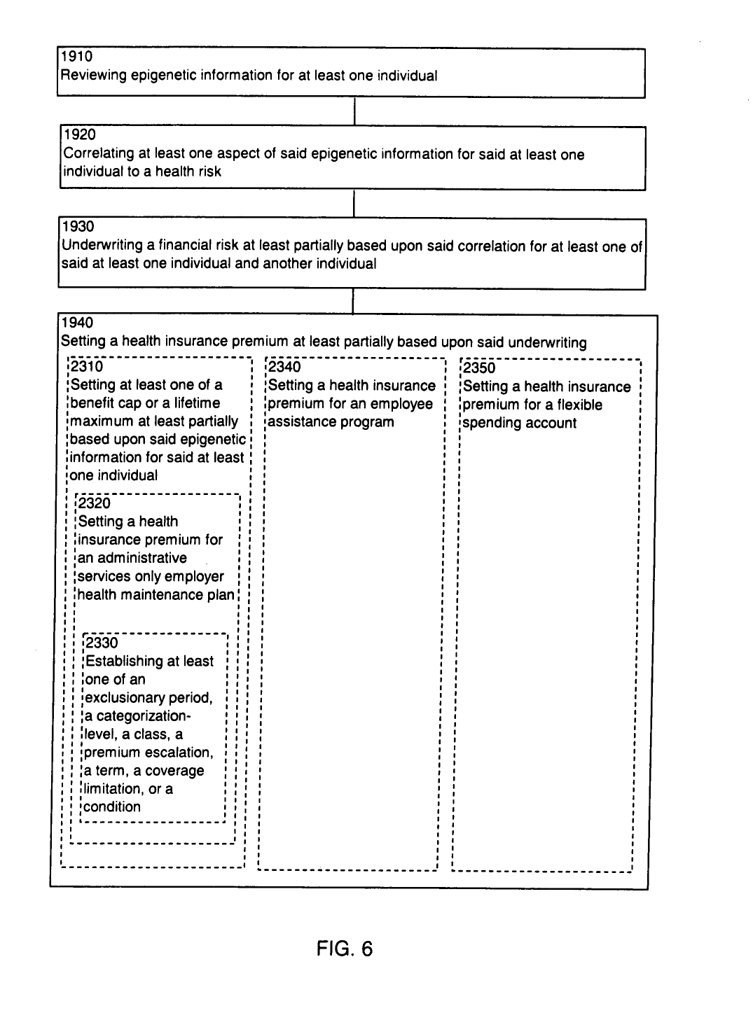

FIG. 6 shows aspects of the flowchart depicted in FIG. 2. Block 1910 depicts reviewing epigenetic information for at least one individual. Block 1920 depicts correlating at least one aspect of epigenetic information for at least one individual to a health risk. Block 1930 depicts underwriting a financial risk at least partially based upon correlation for at least one individual and another individual. Block 1940 depicts setting a health insurance premium at least partially based upon underwriting. Optional block 2310 depicts reviewing epigenetic information for at least one individual by setting at least one of a benefit cap or a lifetime maximum at least partially based upon epigenetic information for at least one individual. In one instance, setter module 144 may devise a benefit cap of five hundred thousand dollars and a lifetime maximum of ten million dollars for a health insurance policy issued to John Smith and based upon John Smith's information regarding the spatial relationship of the genomic loci within a cell. In some instances, a benefit cap or a lifetime maximum setter module 144 may include a computer processor, a mortality table, and/or an actuarial table. A benefit cap may include the total dollar amount a payer will reimburse for covered health care services during a predetermined amount of time. A lifetime maximum may include a cap on the benefits paid for the duration of a health insurance policy. Optional block 2320 depicts setting a health insurance premium at least partially based upon underwriting by setting a health insurance premium for an administrative services only employer health maintenance plan. In one instance, a setter module 144 may formulate a premium rate of two hundred dollars per month for John Smith where John Smith's employer contracted a third party administrator to deliver John Smith's benefits. In some instances, an administrative services only employer health maintenance plan insurance premium setter module 144 may include a computer processor, a mortality table, and/or an actuarial table. An administrative services only employer health maintenance plan may include an arrangement in which an employer hires a third party to deliver employee benefit administrative services to the employer. Optional block 2330 depicts setting a health insurance premium for an administrative services only employer health maintenance plan by establishing at least one of an exclusionary period, a categorization-level, a class, a premium escalation, a term, a coverage limitation, or a condition. In a specific instance, establisher module 146 may set a health insurance policy premium of six hundred dollars per year for Mark Smith based upon quantified risk increased by risk underwriter module 160 with an exclusionary period of one month and a term of ten years. In another specific instance, establisher module 146 may set a health insurance policy premium for Mark Smith for eight hundred dollars per month based on a quantified risk increased by risk underwriter module 160 with a moderate risk categorization-level, a coverage limitation limiting coverage to not include pre-existing conditions, a premium escalation to include mandatory raised premiums after ten years of coverage, and a condition that none of the applicants/insureds have a heart attack during the term. In some instances, an establisher module 146 may include a computer processor, an actuarial table, and/or a mortality table. An exclusionary period may include a predetermined amount of time an insured may be required to wait before insurance coverage may begin. A categorization-level may include a predetermined group of insureds meeting a certain risk threshold. A class may include a predetermined group of people and/or insurance policies with similar attributes. A premium escalation may include a rise in insurance policy premium rates. A term may include a specified amount of time, such as a term of an insurance policy. A coverage limitation may include items not covered by an insurance policy, such as pre-existing conditions. A condition may include a situation potentially affecting the eligibility of insurance coverage, such as disease, injury, and/or illness.

Optional block 2340 depicts setting a health insurance premium at least partially based upon underwriting by setting a health insurance premium for an employee assistance program. In one instance, setter module 144 may provide a health insurance premium of one hundred and fifty dollars per month for an employee assistance program offered to Mark Smith by his employer. In some instances, an employee assistance program health insurance premium setter module 144 may include a computer processor, a mortality table, and/or an actuarial table. An employee assistance program may include a mental health counseling service often offered by insurance companies or employers. Optional block 2350 depicts setting a health insurance premium at least partially based upon underwriting by setting a health insurance premium for a flexible spending account. In one instance, setter module 144 may specify a health insurance premium of fifty dollars per month for a flexible spending account opened by John Smith through his employer. In some instances, a flexible spending account health insurance premium setter module 144 may include a computer processor, a mortality table, and/or an actuarial table. A flexible spending account may include an employee benefits cash account from which non-taxable withdraws may be made to fund eligible expenses defined by the employer-sponsored plan.

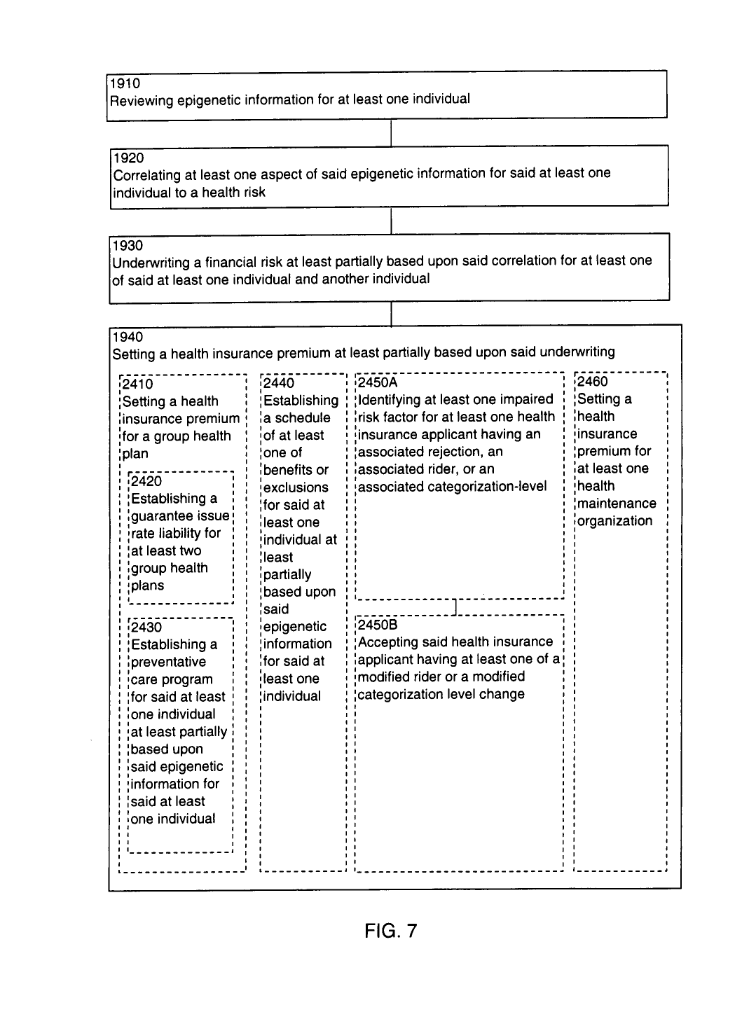

FIG. 7 shows aspects of the flowchart depicted in FIG. 2. Block 1910 depicts reviewing epigenetic information for at least one individual. Block 1920 depicts correlating at least one aspect of epigenetic information for at least one individual to a health risk. Block 1930 depicts underwriting a financial risk at least partially based upon correlation for at least one individual and another individual. Block 1940 depicts setting a health insurance premium at least partially based upon the underwriting. Optional block 2410 depicts setting a health insurance premium at least partially based upon underwriting by setting a health insurance premium for a group health plan. In one instance, setter module 144 fixes a group health plan premium of one hundred and fifty dollars per month per person for a group of employees and their families sponsored by Mark Smith's employer. In some instances, a group health plan premium setter module 144 may include a computer processor. A group health plan may include a health plan providing health coverage to employees and their families which is supported by the employer and/or an employer organization. Optional block 2420 depicts setting a health insurance premium for a group health plan by establishing a guarantee issue rate liability for at least two group health plans. In one specific instance, establisher module 146 determines a positive guarantee issue rate for two health insurance group plans sponsored by Mark Smith's employer and by Davy Jones' employer. The guarantee issue rate guarantees that members in the group plans will be issued coverage for the next five years even though any one member has a prior medical history involving heart disease. In some instances, a guarantee issue rate liability establisher module 146 may include a computer processor and/or an actuarial table. A guarantee issue rate liability may include an insurance policy in which a health insurance company or HMO must issue coverage to an applicant regardless of prior medical history. Optional block 2430 depicts setting a health insurance premium for a group health plan by establishing a preventative care program for at least one individual at least partially based upon epigenetic information for at least one individual. In one instance, establisher module 146 creates a preventative care program for Erik Anderson based on epigenetic information retrieved from network storage 188 regarding a correlation between Erik Anderson's histone structure characteristics and diabetes. In some instances, a preventative care program establisher module 146 may include a computer processor and/or an actuarial table. A preventative care program may include a program which emphasizes preventative measures and/or health screenings. Preventative measures and health screenings may include routine physicals, well-baby care, immunizations, diagnostic tab and x-ray tests, pap smears, mammograms, and/or other types of early detection testing. Optional block 2440 depicts setting a health insurance premium at least partially based upon underwriting by establishing a schedule of at least one of benefits or exclusions for at least one individual at least partially based upon epigenetic information for at least one individual. In a specific instance, establisher module 146 determines a partial schedule of benefits including extra coverage for hospital stays and a partial schedule of exclusions including no coverage for emergency room visits for an individual, Erik Anderson, bawed on epigenetic information regarding Erik Anderson's methylation at a specific DNA region. In some instances, a schedule of at least one of benefits or exclusions establisher module 146 may include a computer processor and/or an actuarial table. A schedule of at least one of benefits or exclusions may include a listing of the benefits which are covered under the policy guidelines as well as services which are not provided under the policy. Optional block 2450A depicts setting a health insurance premium at least partially based upon underwriting by identifying at least one impaired risk factor for at least one health insurance applicant having an associated rejection, an associated rider, or an associated categorization-level. In one instance, identifier module 197 classifies an impaired risk factor including hypertension for applicant Bill Black where a rider for increasing coverage relating to doctor office visits applies, which may otherwise require rejection, a rider, and/or a categorization-level without at least one of a rider and/or a categorization level change. In some instances, an impaired risk factor identifier 187 may include a computer processor and/or an actuarial table. Optional block 2450B depicts setting a health insurance premium at least partially based upon underwriting by accepting the health insurance applicant having at least one of a modified rider or a modified categorization level change. In one instance, accepter module 150 approves a health insurance agreement for Bill Black with a modified rider having provisions for the option for additional health insurance coverage without having to provide a certificate of insurability. In some instances, accepter module may include a computer processor. Optional block 2460 depicts setting a health insurance premium at least partially based upon underwriting by setting a health insurance premium for at least one health maintenance organization. In one instance, setter module 144 may determine a premium of three hundred dollars per month for Mark Smith for a health maintenance organization health insurance policy. In some instances, a health maintenance organization insurance premium setter 144 may include a computer processor and/or an actuarial table. A health maintenance organization (“HMO”) may include a prepaid health plan which may cover doctor's visits, hospital stays, emergency care, surgery, preventative care, check-ups, lab tests, x-rays, therapy, and/or other medical care.

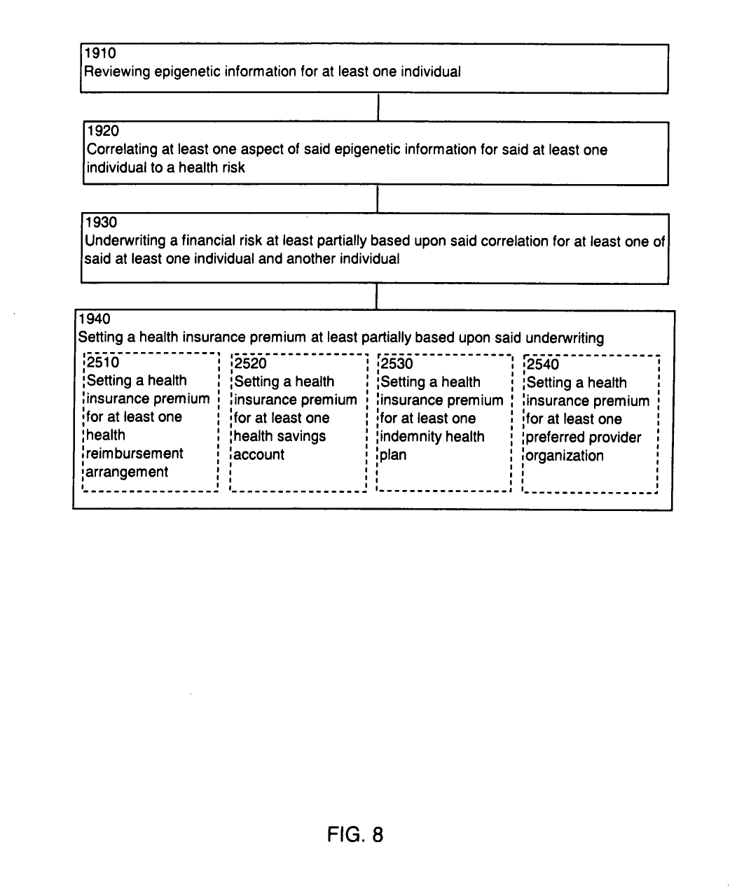

FIG. 8 shows aspects of the flowchart depicted in FIG. 2. Block 1910 depicts reviewing epigenetic information for at least one individual. Block 1920 depicts correlating at least one aspect of epigenetic information for at least one individual to a health risk. Block 1930 depicts underwriting a financial risk at least partially based upon the correlation for at least one individual and another individual. Block 1940 depicts setting a health insurance premium at least partially based upon underwriting. Optional block 2510 depicts setting a health insurance premium at least partially based upon underwriting by setting a health insurance premium for at least one health reimbursement arrangement. In one instance, setter module 144 creates a health reimbursement arrangement premium to be four hundred and seventy five dollars per month for a specific human (e.g. Bill Jones). In some instances, a health insurance premium for at least one health reimbursement arrangement setter 144 may include a computer processor and/or an actuarial table. A health reimbursement arrangement may include a tax-advantaged employee health spending account funded and owned by the employer. Optional block 2520 depicts setting a health insurance premium at least partially based upon underwriting by setting a health insurance premium for at least one health savings account. In one instance, setter module 144 may be programmed to implement a health savings account premium for Bill Jones to be two hundred and twenty five dollars per month. In some instances, a health insurance premium for at least one health savings account setter 144 may include a computer processor and/or an actuarial table. A health savings account may include a tax-advantaged savings account for health care services. Optional block 2530 depicts setting a health insurance premium at least partially based upon the underwriting by setting a health insurance premium for at least one indemnity health plan. In one instance, setter module 144 may be configured to implement an indemnity health plan premium to be one hundred and eighty five dollars per month for a single individual, such as Bill Jones. In some instances, a health insurance premium for at least one indemnity health plan setter 144 may include a computer processor and/or an actuarial table. An indemnity health plan may include a plan where the individual or policy holder pays a predetermined percentage of the cost of health services, and the health care plan pays the remaining percentage. A policy holder may include an individual, a group of individuals, and/or an entity. For example, an individual may pay 10% for health services and the insurance company pays the remaining 90% of health service costs. Optional block 2540 depicts setting a health insurance premium at least partially based upon the underwriting by setting a health insurance premium for at least one preferred provider organization. In one instance, setter module 144 may be coded to establish a preferred provider organization health insurance premium to be five hundred and ten dollars per month for a single individual, such as Bill Jones. In some instances, a health insurance premium for at least one preferred provider organization setter 144 may include a computer processor and/or an actuarial table. A preferred provider organization may include a network of health care providers with which a health insurer has negotiated contracts for its insured population to receive health services at discounted costs.

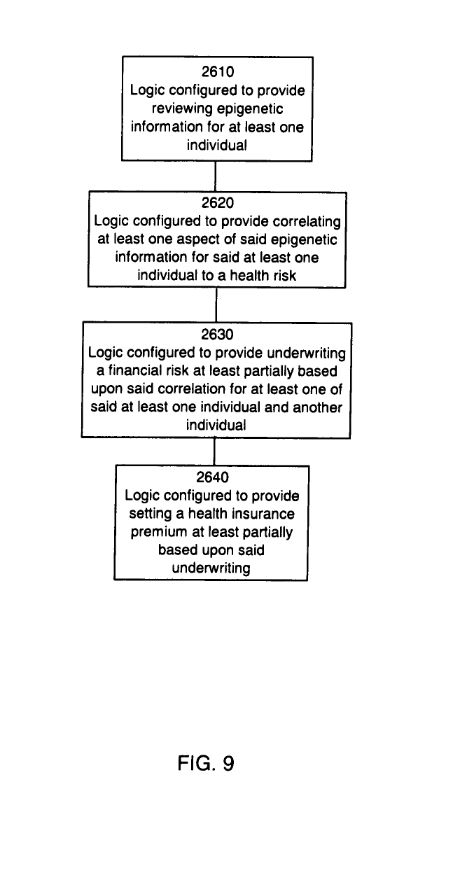

Referring generally to FIGS. 9 through 17, a device is disclosed for reviewing epigenetic information for at least one individual and underwriting a risk at least partially based upon the epigenetic information for at least one individual.

FIG. 9 shows a device. Block 2610 depicts hardware/software/firmware configured to provide reviewing epigenetic information for at least one individual. Reviewing epigenetic information may include collecting, conveying, and/or analyzing the epigenetic information. A reviewer 140 may include a computer processor, an information collection center, or an insurance company. Block 2620 depicts hardware/software/firmware configured to provide correlating at least one aspect of epigenetic information for at least one individual to a health risk. A correlator 162 may include a computer processor or actuarial tables. In various aspects, correlating at least one aspect of epigenetic information for at least one individual to a health risk may include, for example, at least one linear correlation, at least one nonlinear correlation, functional dependency or other mathematical relationship. Block 2630 depicts hardware/software/firmware configured to provide underwriting a financial risk at least partially based upon correlation for at least one individual or another individual. Underwriting a risk may generally involve quantifying, selecting, classifying, analyzing, and assuming risk for an insurance applicant according to the degree of insurability so that the insurance applicant may be charged an appropriate premium rate. A financial risk underwriter 160 may include a computer processor, an insurance company, actuarial tables and/or mortality tables. Block 2640 depicts hardware/software/firmware configured to provide setting a health insurance premium at least partially based upon the underwriting. A health insurance premium setter may include a computer processor, an actuarial table, and/or a mortality table.

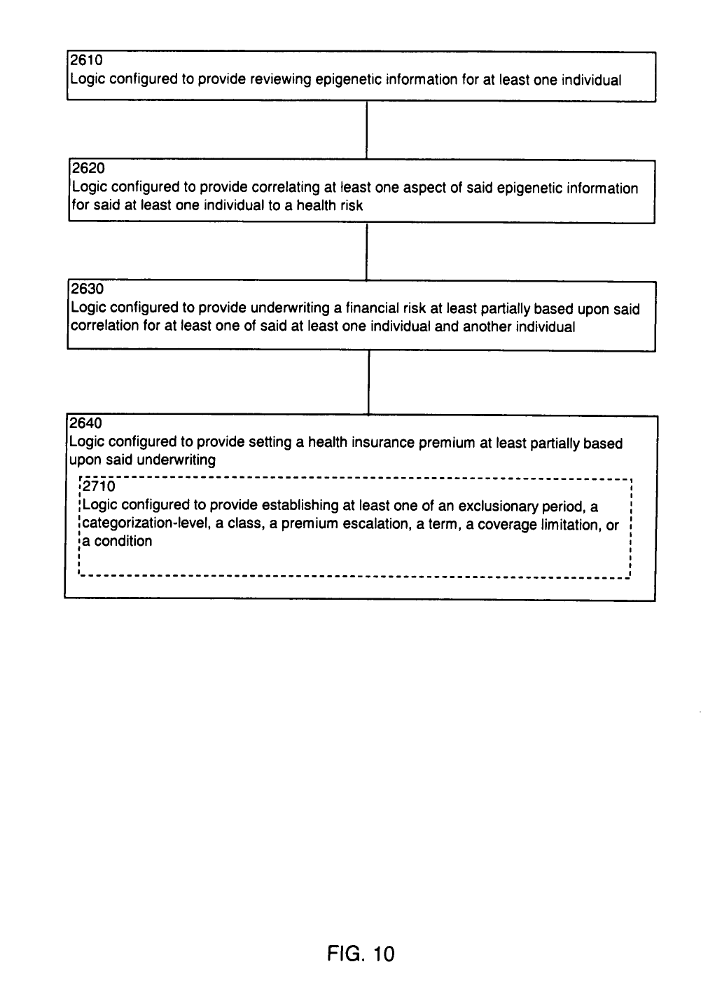

FIG. 10 shows aspects of the device in FIG. 9. Block 2610 depicts hardware/software/firmware configured to provide reviewing epigenetic information for at least one individual. A reviewer 140 may include a computer processor, an information collection center, or an insurance company. Block 2620 depicts hardware/software/firmware configured to provide correlating at least one aspect of epigenetic information for at least one individual to a health risk. A correlator 162 may include a computer processor or actuarial tables. Block 2630 depicts hardware/software/firmware configured to provide underwriting a financial risk at least partially based upon the correlation for at least one individual or another individual. A financial risk underwriter 160 may include a computer processor, an insurance company, actuarial tables and/or mortality tables. Block 2640 depicts hardware/software/firmware configured to provide setting a health insurance premium at least partially based upon the underwriting. A health insurance premium setter may include a computer processor, an actuarial table, and/or a mortality table. Optional block 2710 depicts hardware/software/firmware configured to provide setting a health insurance premium at least partially based upon the underwriting by utilizing hardware/software/firmware configured to provide establishing at least one of an exclusionary period, a categorization-level, a class, a premium escalation, a term, a coverage limitation, or a condition. An establisher 146 may include a computer processor, an actuarial table, and/or a mortality table. An exclusionary period may include a predetermined amount of time an insured may be required to wait before insurance coverage may begin. A categorization-level may include a predetermined group of insureds meeting a certain risk threshold. A class may include a predetermined group of people and/or insurance policies with similar attributes. A premium escalation may include a rise in insurance policy premium rates. A term may include a specified amount of time, such as a term of an insurance policy. A coverage limitation may include items not covered by an insurance policy, such as pre-existing conditions. A condition may include a situation potentially affecting the eligibility of insurance coverage, such as disease, injury, and/or illness.

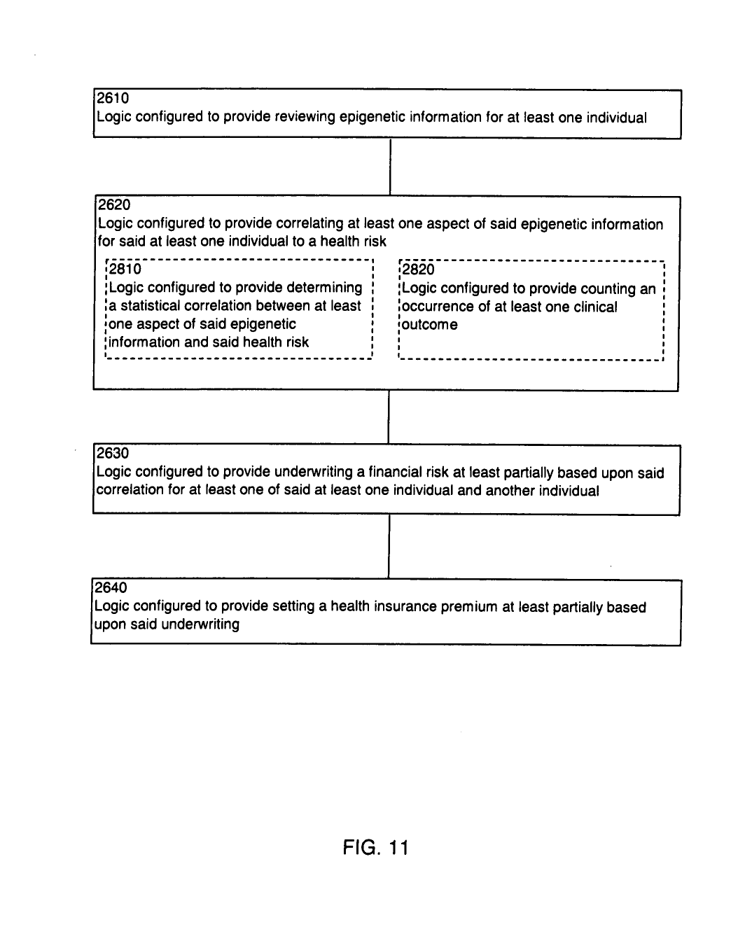

FIG. 11 shows aspects of the device in FIG. 9. Block 2610 depicts hardware/software/firmware configured to provide reviewing epigenetic information for at least one individual. A reviewer 140 may include a computer processor, an information collection center, or an insurance company. Block 2620 depicts hardware/software/firmware configured to provide correlating at least one aspect of epigenetic information for at least one individual to a health risk. A correlator 162 may include a computer processor or actuarial tables. Optional block 2810 depicts hardware/software/firmware configured to provide correlating at least one aspect of epigenetic information for at least one individual to a health risk by utilizing hardware/software/firmware configured to provide determining a statistical correlation between at least one aspect of epigenetic information and the health risk. A statistical correlation determiner 148 may include a computer processor or an actuarial table. A statistical correlation may include, for example, at least one linear correlation, at least one nonlinear correlation, functional dependency or other mathematical relationship. The statistical correlation may or may not be associated with some type of causality, real or implied, proven or unproven. Optional block 2820 depicts hardware/software/firmware configured to provide correlating at least one aspect of epigenetic information for at least one individual to a health risk by utilizing hardware/software/firmware configured to provide counting an occurrence of at least one clinical outcome. A counter 166 may include a computer processor. The counting an occurrence of at least one clinical outcome may include counting a single occurrence of an outcome, such as, for example, a genomic imprinting, a gene mutation, and/or a certain phenotype. Block 2630 depicts hardware/software/firmware configured to provide underwriting a financial risk at least partially based upon the correlation for at least one of at least one individual or another individual. A financial risk underwriter 160 may include a computer processor, an insurance company, actuarial tables and/or mortality tables. Block 2640 depicts hardware/software/firmware configured to provide setting a health insurance premium at least partially based upon the underwriting. A health insurance premium setter may include a computer processor, an actuarial table, and/or a mortality table.

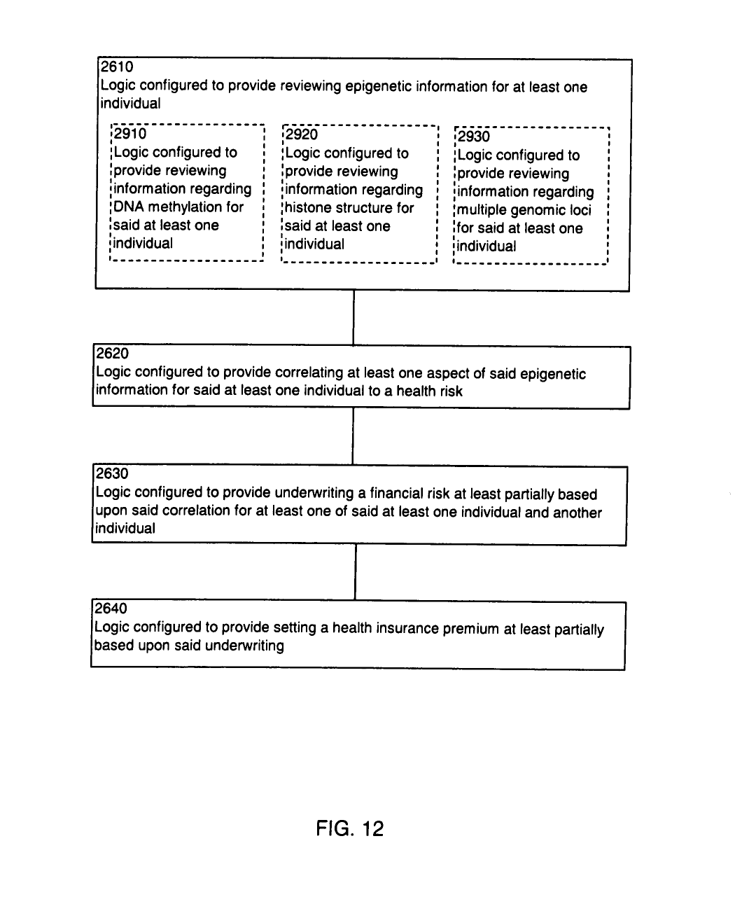

FIG. 12 shows aspects of the device in FIG. 9. Block 2610 depicts hardware/software/firmware configured to provide reviewing epigenetic information for at least one individual. A reviewer 140 may include a computer processor, an information collection center, or an insurance company. Optional block 2910 depicts hardware/software/firmware configured to provide reviewing epigenetic information for at least one individual by utilizing hardware/software/firmware configured to provide reviewing information regarding DNA methylation for at least one individual. An epigenetic information (DNA methylation) reviewer 152 may include a computer processor. For example, reviewing information regarding DNA methylation for at least one individual may include information regarding the methylation status of DNA generally or in the aggregate, or information regarding DNA methylation at one or more specific DNA loci, DNA regions, or DNA bases. See, for example: Shilatifard, Chromatin modifications by methylation and ubiquitination: implications in the regulation of gene expression, ANNUAL REVIEW OF BIOCHEMISTRY, 75:243-269 (2006); and Zhu and Yao, Use of DNA methylation for cancer detection and molecular classification, JOURNAL OF BIOCHEMISTRY AND MOLECULAR BIOLOGY, 40:135-141 (2007), each of which are incorporated herein by reference.

Optional block 2920 depicts hardware/software/firmware configured to provide reviewing epigenetic information for at least one individual by utilizing hardware/software/firmware configured to provide reviewing information regarding histone structure for at least one individual. An epigenetic information (histone structure) reviewer 152 may include a computer processor. For example, reviewing information regarding histone structure for at least one individual may include information regarding histone structure generally or in the aggregate, or histone structure at one or more specific locations including one or more chromosomes. Information regarding histone structure may, for example, include information regarding specific subtypes or classes of histones, such as H1, H2A, H2B, H3 or H4. Information regarding histone structure may have an origin in array-based techniques, such as described in Barski et al., High-resolution profiling of histone methylations in the human genome, CELL 129, 823-837 (2007), which is incorporated herein by reference.

Optional block 2930 depicts hardware/software/firmware configured to provide reviewing epigenetic information for at least one individual by utilizing hardware/software/firmware configured to provide reviewing information regarding multiple genomic loci for at least one individual. An epigenetic information (multiple genomic loci) reviewer 152 may include a computer processor. For example, in some examples reviewing information regarding multiple genomic loci for at least one individual may include information regarding multiple genomic loci throughout one or more genomes, multiple genomic loci located on one or more chromosomes or chromosomal arms, or multiple genomic loci located in a specific chromosomal region. Information regarding multiple genomic loci may also include information regarding different epigenetic effects at different genomic loci. See, for example, The ENCODE Project Consortium, Identification and analysis of functional elements in 1% of the human genome by the ENCODE pilot project, NATURE 447: 799-816 (2007), which is incorporated herein by reference. For example, in some examples the information regarding multiple genomic loci may include information regarding both DNA methylation and histone modifications. See, for example, Berger, The Complex Language of Chromatin Regulation During Transcription, NATURE 477, 407-412 (2007), and Greatly, Encyclopaedia of Humble DNA, NATURE 447: 782-783 (2007), which are incorporated herein by reference. In some examples, the information regarding multiple genomic loci may include information regarding the predicted stability of the epigenetic status at the multiple genomic loci. See, for example, Dodd et at., Theoretical Analysis of Epigenetic Cell Memory by Nucleosome Modification, CELL 129, 813-822 (2007), which is incorporated herein by reference. In some examples, the information regarding multiple genomic loci may include information regarding the spatial relationship of the genomic loci within at least one cell. For example, see Fraser and Bickmore, Nuclear Organization of the Genome and the Potential for Gene Regulation, NATURE 477: 413-417 (2007), which is incorporated herein by reference. In some examples, the information regarding multiple genomic loci may include information regarding binding of one or more proteins to multiple genomic loci. See, for example, Xie et at., Systematic Discovery of Regulatory Motifs in Conserved Regions of the Human Genome, Including Thousands of CTCF Insulator Sites, PNAS USA 104: 7145-7150 (2007), which is incorporated herein by reference.

Block 2620 depicts hardware/software/firmware configured to provide correlating at least one aspect of epigenetic information for at least one individual to a health risk. A correlator 162 may include a computer processor or actuarial tables. Block 2630 depicts hardware/software/firmware configured to provide underwriting a financial risk at least partially based upon the correlation for at least one of at least one individual or another individual. A financial risk underwriter 160 may include a computer processor, an insurance company, actuarial tables and/or mortality tables. Block 2640 depicts hardware/software/firmware configured to provide setting a health insurance premium at least partially based upon underwriting. A health insurance premium setter may include a computer processor, an actuarial table, and/or a mortality table.

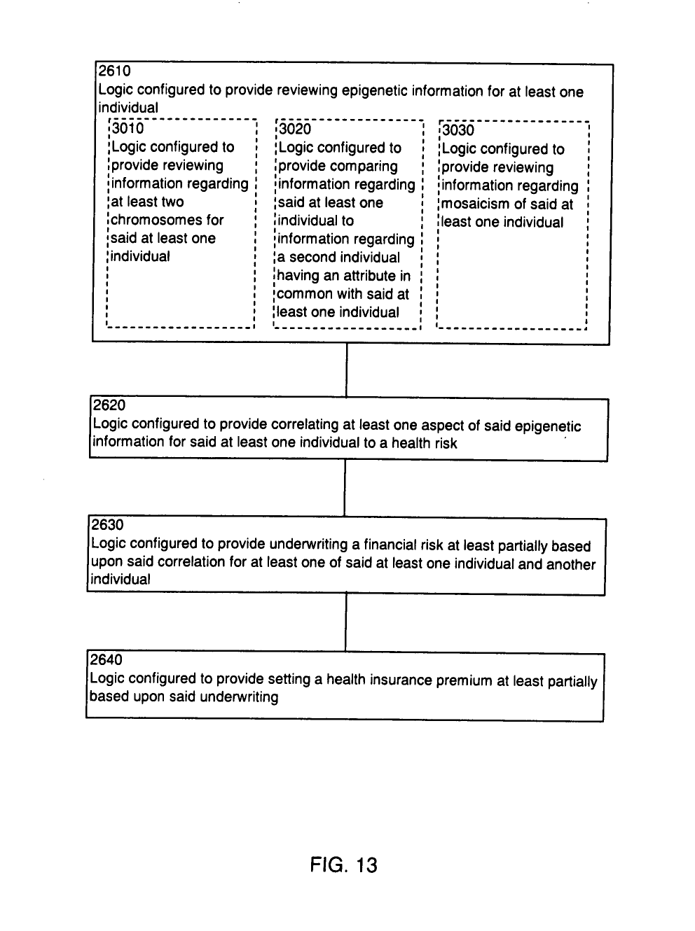

FIG. 13 shows aspects of the device in FIG. 9. Block 2610 depicts hardware/software/firmware configured to provide reviewing epigenetic information for at least one individual. A reviewer 140 may include a computer processor, an information collection center, or an insurance company. Optional block 3010 depicts hardware/software/firmware configured to provide reviewing epigenetic information for at least one individual by utilizing hardware/software/firmware configured to provide reviewing information regarding at least two chromosomes for at least one individual. An epigenetic information (chromosome information) reviewer 152 may include a computer processor. For example, in some examples reviewing information regarding at least two chromosomes for at least one individual may include information regarding at least two homologous chromosomes, sister chromatids, or nonhomologous chromosomes. In some examples, at least one aspect of epigenetic information may include information regarding at least two chromosomes including the copy number of the at least two chromosomes. See, for example, Redon et al., Global Variation in Copy Number in the Human Genome, NATURE 444: 444-454 (2006) and Shianna and Willard, In Search of Normality, NATURE 444: 428-429 (2006), which are incorporated herein by reference.

Optional block 3020 depicts hardware/software/firmware configured to provide reviewing epigenetic information for at least one individual by utilizing hardware/software/firmware configured to provide comparing information regarding at least one individual to information regarding a second individual having an attribute in common with at least one individual. A comparer 142 may include a computer processor. For example, at least one aspect of epigenetic information may include information regarding two or more people with a common attribute such as gender, height, weight, diabetes status, heart disease status, medical diagnosis, familial background, results on one or more medical tests, or ethnic background. For example, a common attribute may include environmental attributes, such as exposure to a pathogen, a teratogen, a chemical substance.

Optional block 3030 depicts hardware/software/firmware configured to provide reviewing epigenetic information for at least one individual by utilizing hardware/software/firmware configured to provide reviewing information regarding mosaicism of at least one individual. An epigenetic information (mosaicism) reviewer 152 may include a computer processor. The term “mosaicism,” as used herein, may mean situations where two or more cellular subtypes arise during the lifespan of an organism, situations where two or more cellular subtypes originate with the first cell of an organism and situations where the origin of the cellular subtypes is unclear. The term “mosaicism” may generally include somatic mosaicism, gonadal mosaicism, or chimerism. For example, at least one aspect of epigenetic information may include information regarding mosaicism of at least one individual person such as the presence or absence of mosaicism, the location of mosaicism, the tissue or tissues involved in the mosaicism, or the proportion of various subtypes of cells in mosaic tissue. For more information on somatic mosaicism and disease, see Youssoufian and Pyeritz, Mechanisms and Consequences of Somatic Mosaicism in Humans, Nature Reviews Genetics 3: 748-758 (2002), which is incorporated herein by reference.

Block 2620 depicts hardware/software/firmware configured to provide correlating at least one aspect of epigenetic information for at least one individual to a health risk. A correlator 162 may include a computer processor or actuarial tables. Block 2630 depicts hardware/software/firmware configured to provide underwriting a financial risk at least partially based upon the correlation for at least one of at least one individual or another individual. A financial risk underwriter 160 may include a computer processor, an insurance company, actuarial tables and/or mortality tables. Block 2640 depicts hardware/software/firmware configured to provide setting a health insurance premium at least partially based upon underwriting. A health insurance premium setter may include a computer processor, an actuarial table, and/or a mortality table.

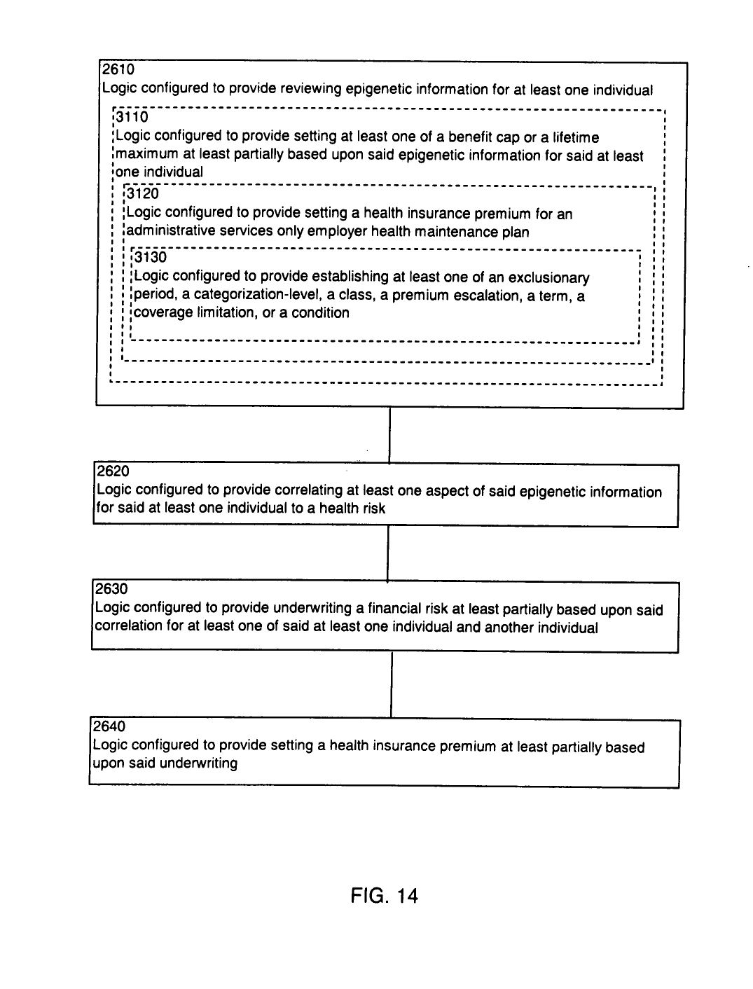

FIG. 14 shows aspects of the device in FIG. 9. Block 2610 depicts hardware/software/firmware configured to provide reviewing epigenetic information for at least one individual. A reviewer 140 may include a computer processor, an information collection center, or an insurance company. Optional block 3110 depicts hardware/software/firmware configured to provide reviewing epigenetic information for at least one individual by utilizing hardware/software/firmware configured to provide setting at least one of a benefit cap or a lifetime maximum at least partially based upon epigenetic information for at least one individual. A benefit cap or a lifetime maximum setter 144 may include a computer processor, a mortality table, and/or an actuarial table. A benefit cap may include the total dollar amount a payer will reimburse for covered health care services during a predetermined amount of time. A lifetime maximum may include a cap on the benefits paid for the duration of a health insurance policy. Optional block 3120 depicts hardware/software/firmware configured to provide setting a health insurance premium at least partially based upon underwriting by utilizing hardware/software/firmware configured to provide setting a health insurance premium for an administrative services only employer health maintenance plan. An administrative services only employer health maintenance plan insurance premium setter may include a computer processor, a mortality table, and/or an actuarial table. An administrative services only employer health maintenance plan may include an arrangement in which an employer hires a third party to deliver employee benefit administrative services to the employer. Optional block 3130 depicts hardware/software/firmware configured to provide setting a health insurance premium for an administrative services only employer health maintenance plan by utilizing hardware/software/firmware configured to provide establishing at least one of an exclusionary period, a categorization-level, a class, a premium escalation, a term, a coverage limitation, or a condition. An establisher 146 may include a computer processor, a mortality table, and/or an actuarial table. An exclusionary period may include a predetermined amount of time an insured may be required to wait before insurance coverage may begin. A categorization-level may include a predetermined group of insureds meeting a certain risk threshold. A class may include a predetermined group of people and/or insurance policies with similar attributes. A premium escalation may include a rise in insurance policy premium rates. A term may include a specified amount of time, such as a term of an insurance policy. A coverage limitation may include items not covered by an insurance policy, such as pre-existing conditions. A condition may include a situation potentially affecting the eligibility of insurance coverage, such as disease, injury, and/or illness.

Block 2620 depicts hardware/software/firmware configured to provide correlating at least one aspect of epigenetic information for at least one individual to a health risk. A correlator 162 may include a computer processor or actuarial tables. Block 2630 depicts hardware/software/firmware configured to provide underwriting a financial risk at least partially based upon correlation for at least one individual or another individual. A financial risk underwriter 160 may include a computer processor, an insurance company, actuarial tables and/or mortality tables. Block 2640 depicts hardware/software/firmware configured to provide setting a health insurance premium at least partially based upon underwriting. A health insurance premium setter may include a computer processor, an actuarial table, and/or a mortality table.

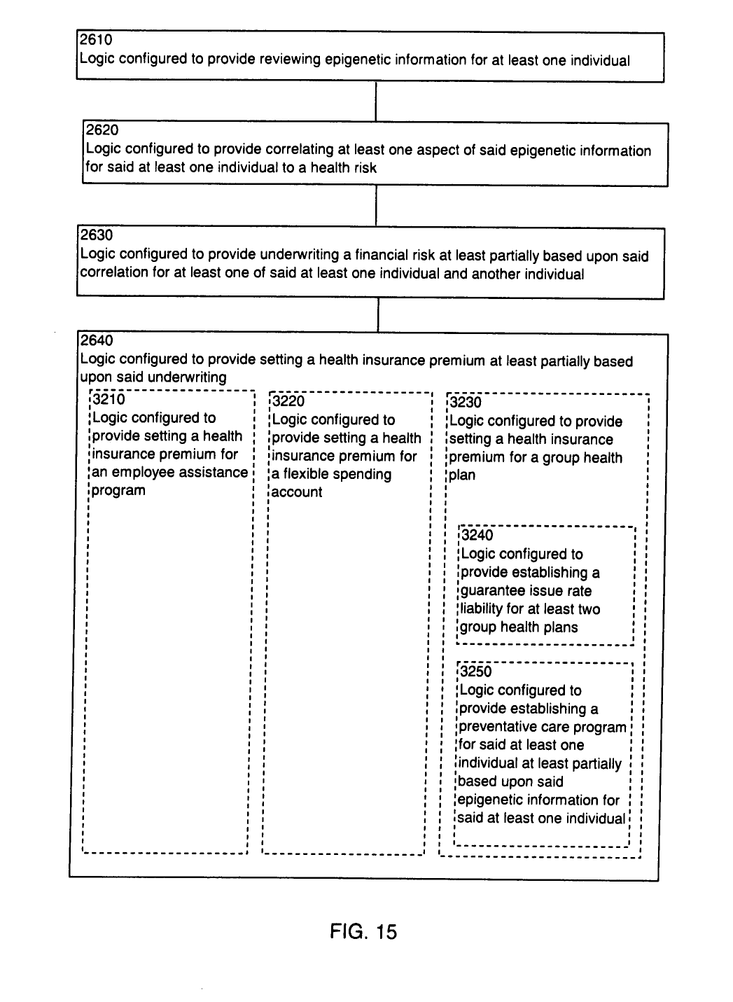

FIG. 15 shows aspects of the device in FIG. 9. Block 2610 depicts hardware/software/firmware configured to provide reviewing epigenetic information for at least one individual. A reviewer 140 may include a computer processor, an information collection center, or an insurance company. Block 2620 depicts hardware/software/firmware configured to provide correlating at least one aspect of epigenetic information for at least one individual to a health risk. A correlator 162 may include a computer processor or actuarial tables. Block 2630 depicts hardware/software/firmware configured to provide underwriting a financial risk at least partially based upon correlation for at least one individual or another individual. A financial risk underwriter 160 may include a computer processor, an insurance company, actuarial tables and/or mortality tables. Block 2640 depicts hardware/software/firmware configured to provide setting a health insurance premium at least partially based upon underwriting. A health insurance premium setter may include a computer processor, an actuarial table, and/or a mortality table. Optional block 3210 depicts hardware/software/firmware configured to provide setting a health insurance premium at least partially based upon underwriting by utilizing hardware/software/firmware configured to provide setting a health insurance premium for an employee assistance program. An employee assistance program health insurance premium setter 144 may include a computer processor, a mortality table, and/or an actuarial table. An employee assistance program may include a mental health counseling service often offered by insurance companies or employers. Optional block 3220 depicts hardware/software/firmware configured to provide setting a health insurance premium at least partially based upon underwriting by utilizing hardware/software/firmware configured to provide setting a health insurance premium for a flexible spending account. A flexible spending account health insurance premium setter 144 may include a computer processor, a mortality table, and/or an actuarial table. A flexible spending account may include an employee benefits cash account from which non-taxable withdraws may be made to fund eligible expenses defined by the employer-sponsored plan. Optional block 3230 depicts hardware/software/firmware configured to provide setting a health insurance premium at least partially based upon underwriting by utilizing hardware/software/firmware configured to provide setting a health insurance premium for a group health plan. A group health plan premium setter 144 may include a computer processor. A group health plan may include a health plan providing health coverage to employees and their families which is supported by the employer and/or an employer organization. Optional block 3240 depicts hardware/software/firmware configured to provide setting a health insurance premium for a group health plan by utilizing hardware/software/firmware configured to provide establishing a guarantee issue rate liability for at least two group health plans. A guarantee issue rate liability establisher 146 may include a computer processor and/or an actuarial table. A guarantee issue rate liability may include an insurance policy in which a health insurance company or HMO must issue coverage to an applicant regardless of prior medical history. Optional block 3250 depicts hardware/software/firmware configured to provide setting a health insurance premium for a group health plan by utilizing hardware/software/firmware configured to provide establishing a preventative care program for at least one individual at least partially based upon epigenetic information for at least one individual. A preventative care program establisher 146 may include a computer processor and/or an actuarial table. A preventative care program may include a program which emphasizes preventative measures and/or health screenings. Preventative measures and health screenings may include routine physicals, well-baby care, immunizations, diagnostic lab and x-ray tests, pap smears, mammograms, and/or other types of early detection testing.

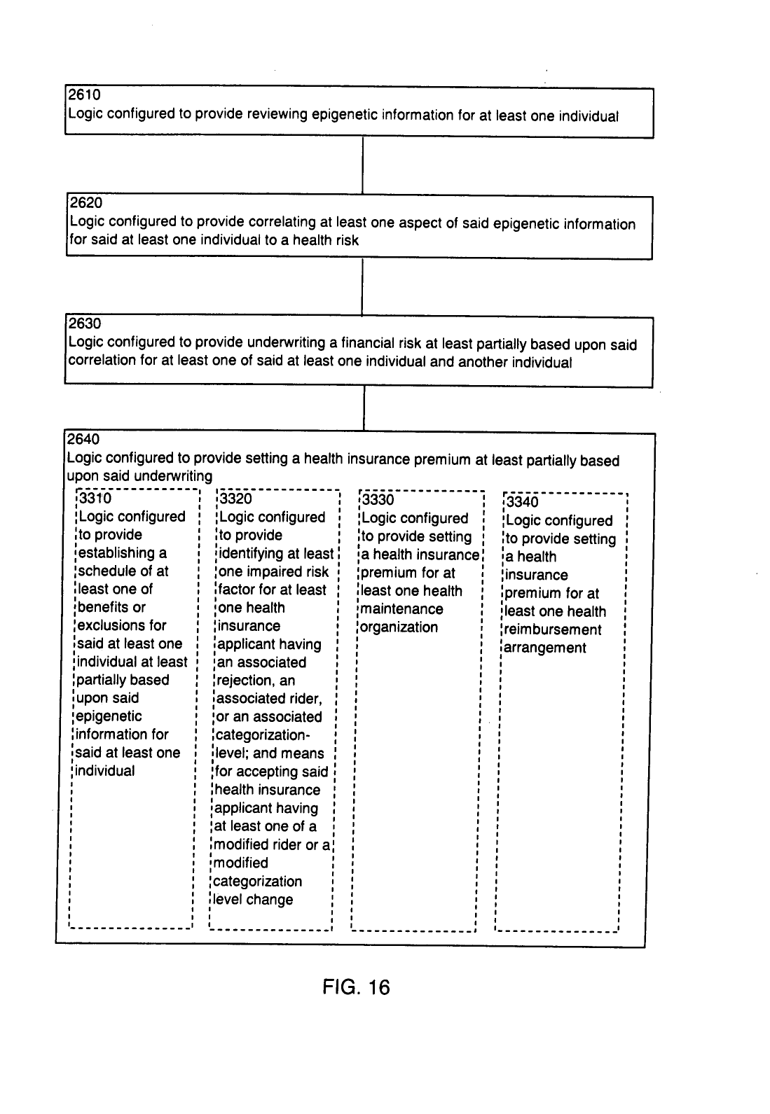

FIG. 16 shows aspects of the device in FIG. 9. Block 2610 depicts hardware/software/firmware configured to provide reviewing epigenetic information for at least one individual. A reviewer 140 may include a computer processor, an information collection center, or an insurance company. Block 2620 depicts hardware/software/firmware configured to provide correlating at least one aspect of epigenetic information for at least one individual to a health risk. A correlator 162 may include a computer processor or actuarial tables. Block 2630 depicts hardware/software/firmware configured to provide underwriting a financial risk at least partially based upon correlation for at least one individual or another individual. A financial risk underwriter 160 may include a computer processor, an insurance company, actuarial tables and/or mortality tables. Block 2640 depicts hardware/software/firmware configured to provide setting a health insurance premium at least partially based upon underwriting. A health insurance premium setter may include a computer processor, an actuarial table, and/or a mortality table. Optional block 3310 depicts hardware/software/firmware configured to provide setting a health insurance premium at least partially based upon underwriting by utilizing hardware/software/firmware configured to provide establishing a schedule of at least one of benefits or exclusions for at least one individual at least partially based upon epigenetic information for at least one individual. A schedule of at least one of benefits or exclusions establisher 146 may include a computer processor and/or an actuarial table. A schedule of at least one of benefits or exclusions may include a listing of the benefits which are covered under the policy guidelines as well as services which are not provided under the policy. Optional block 3320 depicts hardware/software/firmware configured to provide setting a health insurance premium at least partially based upon underwriting by utilizing hardware/software/firmware configured to provide identifying at least one impaired risk factor for at least one health insurance applicant having an associated rejection, an associated rider, or an associated categorization-level and hardware/software/firmware configured to provide accepting the health insurance applicant having at least one of a modified rider or a modified categorization level change. An impaired risk factor identifier 187 may include a computer processor and/or an actuarial table. Optional block 3330 depicts hardware/software/firmware configured to provide setting a health insurance premium at least partially based upon underwriting by utilizing hardware/software/firmware configured to provide setting a health insurance premium for at least one health maintenance organization. A health maintenance organization insurance premium setter 144 may include a computer processor and/or an actuarial table. A health maintenance organization (“HMO”) may include a prepaid health plan which may cover doctor's visits, hospital stays, emergency care, surgery, preventative care, check-ups, lab tests, x-rays, therapy, and/or other medical care. Optional block 3340 depicts hardware/software/firmware configured to provide setting a health insurance premium at least partially based upon underwriting by utilizing hardware/software/firmware configured to provide setting a health insurance premium for at least one health reimbursement arrangement. A health insurance premium for at least one health reimbursement arrangement setter 144 may include a computer processor and/or an actuarial table. A health reimbursement arrangement may include a tax-advantaged employee health spending account funded and owned by the employer.

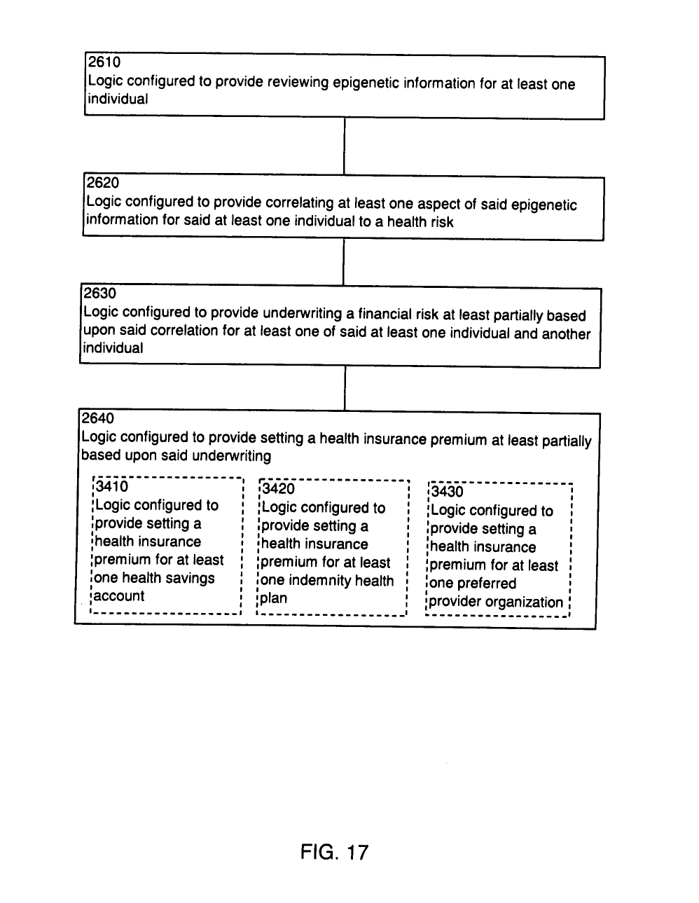

FIG. 17 shows aspects of the device in FIG. 9. Block 2610 depicts hardware/software/firmware configured to provide reviewing epigenetic information for at least one individual. A reviewer 140 may include a computer processor, an information collection center, or an insurance company. Block 2620 depicts hardware/software/firmware configured to provide correlating at least one aspect of epigenetic information for at least one individual to a health risk. A correlator 162 may include a computer processor or actuarial tables. Block 2630 depicts hardware/software/firmware configured to provide underwriting a financial risk at least partially based upon the correlation for at least one individual or another individual A financial risk underwriter 160 may include a computer processor, an insurance company, actuarial tables and/or mortality tables. Block 2640 depicts hardware/software/firmware configured to provide setting a health insurance premium at least partially based upon underwriting. A health insurance premium setter may include a computer processor, an actuarial table, and/or a mortality table. Optional block 3410 depicts hardware/software/firmware configured to provide setting a health insurance premium at least partially based upon underwriting by utilizing hardware/software/firmware configured to provide setting a health insurance premium for at least one health savings account. A health insurance premium for at least one health savings account setter 144 may include a computer processor and/or an actuarial table. A health savings account may include a tax-advantaged savings account for health care services. Optional block 3420 depicts hardware/software/firmware configured to provide setting a health insurance premium at least partially based upon underwriting by utilizing hardware/software/firmware configured to provide setting a health insurance premium for at least one indemnity health plan. A health insurance premium for at least one indemnity health plan setter 144 may include a computer processor and/or an actuarial table. An indemnity health plan may include a plan where the individual or policy holder pays a predetermined percentage of the cost of health services, and the health care plan pays the remaining percentage. A policy holder may include an individual, a group of individuals, and/or an entity. For example, an individual may pay 10% for health services and the insurance company pays the remaining 90% of health service costs. Optional block 3430 depicts hardware/software/firmware configured to provide setting a health insurance premium at least partially based upon underwriting by utilizing hardware/software/firmware configured to provide setting a health insurance premium for at least one preferred provider organization. A health insurance premium for at least one preferred provider organization setter 144 may include a computer processor and/or an actuarial table. A preferred provider organization may include a network of health care providers with which a health insurer has negotiated contracts for its insured population to receive health services at discounted costs.

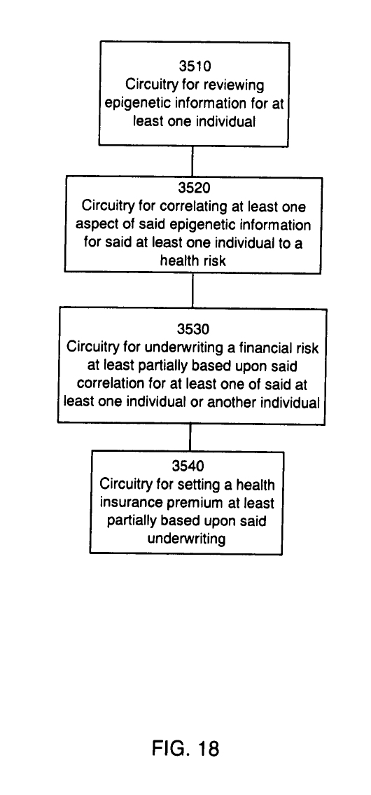

Referring generally to FIG. 18, a device is disclosed for reviewing epigenetic information for at least one individual and underwriting a risk at least partially based upon epigenetic information for at least one individual.

FIG. 18 illustrates a device. Block 3510 depicts circuitry for reviewing epigenetic information for at least one individual. A reviewer 140 may include a computer processor, an information collection center, or an insurance company. Block 3520 depicts circuitry for correlating at least one aspect of epigenetic information for at least one individual to a health risk. A correlator 162 may include a computer processor or actuarial tables. Block 3530 depicts circuitry for underwriting a financial risk at least partially based upon correlation for at least one individual or another individual. A risk underwriter 160 may include a computer processor and/or an insurance company. Block 3540 depicts circuitry for setting a health insurance premium at least partially based upon underwriting. A health insurance premium setter may include a computer processor, an actuarial table, and/or a mortality table.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles a or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. A method comprising:
(a) reviewing epigenetic information for at least one individual;
(b) correlating at least one aspect of said epigenetic information for said at least one individual to a health risk;
(c) underwriting a financial risk at least partially based upon said correlation for at least one of said at least one individual and another individual; and
(d) setting a health insurance premium at least partially based upon said underwriting.

2. A device comprising:
(a) means for reviewing epigenetic information for at least one individual;
(b) means for correlating at least one aspect of said epigenetic information for said at least one individual to a health risk;
(c) means for underwriting a financial risk at least partially based upon said correlation for at least one of said at least one individual or another individual; and
(d) means for setting a health insurance premium at least partially based upon said underwriting.

3. The device of claim 2, wherein said means for setting a health insurance premium at least partially based upon said underwriting comprises:
means for establishing at least one of an exclusionary period, a categorization-level, a class, a premium escalation, a term, a coverage limitation, or a condition.

4. The device of claim 2, wherein said means for correlating at least one aspect of said epigenetic information for said at least one individual to a health risk comprises:
means for determining a statistical correlation between at least one aspect of said epigenetic information and said health risk.

5. The device of claim 2, wherein said means for correlating at least one aspect of said epigenetic information for said at least one individual to a health risk comprises:
means for counting an occurrence of at least one clinical outcome.

6. The device of claim 2, wherein said means for reviewing epigenetic information for at least one individual comprises:
means for reviewing information regarding DNA methylation for said at least one individual.

7. The device of claim 2, wherein said means for reviewing epigenetic information for at least one individual comprises:
means for reviewing information regarding histone structure for said at least one individual.

8. The device of claim 2, wherein said means for reviewing epigenetic information for at least one individual comprises:
means for reviewing information regarding multiple genomic loci for said at least one individual.

9. The device of claim 2, wherein said means for reviewing epigenetic information for at least one individual comprises:
means for reviewing information regarding at least two chromosomes for said at least one individual.

10. The device of claim 2, wherein said means for reviewing epigenetic information for at least one individual comprises:
means for comparing information regarding said at least one individual to information regarding a second individual having an attribute in common with said at least one individual.

11. The device of claim 2, wherein said means for reviewing epigenetic information for at least one individual comprises:
means for reviewing information regarding mosaicism of said at least one individual.

12. The device of claim 2, wherein said means for reviewing epigenetic information for at least one individual comprises:
means for setting at least one of a benefit cap or a lifetime maximum at least partially based upon said epigenetic information for said at least one individual.

13. The device of claim 12, wherein said means for setting a health insurance premium at least partially based upon said underwriting comprises:
means for setting a health insurance premium for an administrative services only employer health maintenance plan.

14. The device of claim 13, wherein said means for setting a health insurance premium for an administrative services only employer health maintenance plan comprises:
means for establishing at least one of an exclusionary period, a categorization-level, a class, a premium escalation, a term, a coverage limitation, or a condition.

15. The device of claim 2, wherein said means for setting a health insurance premium at least partially based upon said underwriting comprises:
means for setting a health insurance premium for an employee assistance program.

16. The device of claim 2, wherein said means for setting a health insurance premium at least partially based upon said underwriting comprises:
means for setting a health insurance premium for a flexible spending account.

17. The device of claim 2, wherein said means for setting a health insurance premium at least partially based upon said underwriting comprises:
means for setting a health insurance premium for a group health plan.

18. The device of claim 17, wherein said means for setting a health insurance premium for a group health plan comprises:
means for establishing a guarantee issue rate liability for at least two group health plans.

19. The device of claim 17, wherein said means for setting a health insurance premium for a group health plan comprises:
means for establishing a preventative care program for said at least one individual at least partially based upon said epigenetic information for said at least one individual.

20. The device of claim 2, wherein said means for setting a health insurance premium at least partially based upon said underwriting comprises:
means for establishing a schedule of at least one of benefits or exclusions for said at least one individual at least partially based upon said epigenetic information for said at least one individual.

21. The device of claim 2, wherein said means for setting a health insurance premium at least partially based upon said underwriting comprises:
means for identifying at least one impaired risk factor for at least one health insurance applicant having an associated rejection, an associated rider, or an associated categorization-level; and
means for accepting said health insurance applicant having at least one of a modified rider or a modified categorization level change.

22. The device of claim 2, wherein said means for setting a health insurance premium at least partially based upon said underwriting comprises:
means for setting a health insurance premium for at least one health maintenance organization.

23. The device of claim 2, wherein said means for setting a health insurance premium at least partially based upon said underwriting comprises:
means for setting a health insurance premium for at least one health reimbursement arrangement.

24. The device of claim 2, wherein said means for setting a health insurance premium at least partially based upon said underwriting comprises:
means for setting a health insurance premium for at least one health savings account.

25. The device of claim 2, wherein said means for setting a health insurance premium at least partially based upon said underwriting comprises:
means for setting a health insurance premium for at least one indemnity health plan.

26. The device of claim 2, wherein said means for setting a health insurance premium at least partially based upon said underwriting comprises:
means for setting a health insurance premium for at least one preferred provider organization.

27. A device comprising:
(a) circuitry for reviewing epigenetic information for at least one individual;
(b) circuitry for correlating at least one aspect of said epigenetic information for said at least one individual to a health risk;
(c) circuitry for underwriting a financial risk at least partially based upon said correlation for at least one of said at least one individual or another individual; and
(d) circuitry for setting a health insurance premium at least partially based upon said underwriting.
